(19) United States
(12) Patent Application Publication
(10) Pub. No.: US 2024/0278605 A1
(43) Pub. Date: Aug. 22, 2024

(54) MULTI-PURPOSE WHEEL WORKSTATION AND USE THEREOF

(71) Applicant: BAJA MOTOCROSS INC., Irvine, CA (US)

(72) Inventors: Alan M. Peterson, JR., Irvine, CA (US); Michael R. Conrad, Irvine, CA (US)

(21) Appl. No.: 18/444,546

(22) Filed: Feb. 16, 2024

Related U.S. Application Data
(60) Provisional application No. 63/446,253, filed on Feb. 16, 2023.

(51) Int. Cl. B60C 25/138; B60C 25/05

(52) U.S. Cl. CPC B60C 25/138; B60C 25/0572

(57) ABSTRACT

A system multi-purpose workstation for an assembly having a wheel and a tire, includes a platform and a plurality of configuration sets detachably coupled with the platform. The platform has a frame and an assembly base coupled to the frame and configured for the assembly to be attached thereon. A use selectively couple one of the configuration sets with the platform to either separate the tire from the wheel or install the tire on the wheel.

### CROSS-REFERENCE TO RELATED APPLICATIONS

This application claims priority to provisional U.S. Pat. Application No. 63/446,253, filed Feb. 16, 2023, now pending. Although incorporated by reference in its entirety, no arguments or disclaimers made in the parent application apply to this non-provisional application. Any disclaimer that may have occurred during the prosecution of the above-referenced application is hereby expressly rescinded.

### TECHNICAL FIELD

The present disclosure relates to equipment facilitating the removal of tires for the purpose of repair or replacement from the wheels upon which they are normally mounted. More particularly, the present disclosure relates to the equipment facilitating breaking tire beads from the rim of a wheel, removing tires from respective wheels, and remounting tires on the corresponding wheels.

### BACKGROUND

Maintaining an inflatable tire on a rim of a wheel while permitting the tire to be readily removed from the rim for repair or replacement has presented a variety of problems over the years.

The lack of clearance between the tire and the rim has made the removal of tires from their rims difficult. A variety of hand tools such as slide bars, hammers, and chisel-like tools have been used to disengage the tire bead from the rim of a wheel. These techniques can require great strength and dexterity on the part of the operator. Furthermore, these hand tool techniques can cause damage to the tire, the tire tube, and rim.

The process of disengaging the tire from the rim of a wheel is frequently referred to as “bead breaking.” After the tire bead is broken, the tire is then stripped from the rim of the wheel.

After the bead breaking process is complete, the tire is only partially decoupled from the wheel. A different set of tools are required to interact with the inner surface of the tire and uses leverage to completely remove the tire from the wheel. However, the tire removal process described above requires moving the wheel from one stand with the bead breaking tools to another stand with the tire removal tools. In the case of changing tires in an outdoor dirt bike setting, changing tires normally means setting up two separate stands, or stand areas, for separate tasks. The process is not only time-consuming but also burdensome because of the components for two stands that need to be brought to the site.

Thus, there is a need for one stand/bench that can accommodate various tire changing procedures that includes tire bead breaking, demounting tire from wheel, and remounting the tire on wheel without the removal of wheels to another stand/bench.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a perspective view of a frame of the multi-purpose workstation according to a first embodiment of the present disclosure;

FIG. 2 is an enlarged perspective view of the frame of the multi-purpose workstation according to the first embodiment of the present disclosure;

FIG. 3 is a perspective view of a hub tool according to the first embodiment of the present disclosure;

FIG. 4 is a side view of the frame according to the first embodiment of the present disclosure;

FIG. 5 is an enlarged side view of the frame of the multi-purpose workstation according to the first embodiment of the present disclosure;

FIG. 6 is a perspective view of the multi-purpose workstation in a bead-breaking configuration according to the first embodiment of the present disclosure;

FIG. 7 is a perspective view of the multi-purpose workstation in a tire-dismounting configuration according to the first embodiment of the present disclosure;

FIG. 8 is a perspective view of the dismounting tool according to the first embodiment of the present disclosure;

FIG. 9 illustrates a tire-remounting tool of the present disclosure;

FIG. 10 is a perspective view of the multi-purpose workstation in a tire-mounting configuration according to the first embodiment of the present disclosure;

FIG. 11 is a perspective of the multi-purpose workstation in a bead-breaking configuration according to a second embodiment of the present disclosure;

FIG. 12 is a perspective of the multi-purpose workstation in a tire dismounting configuration according to the second embodiment of the present disclosure;

FIG. 13 is an enlarged perspective view of the multi-purpose workstation in a tire dismounting configuration according to the second embodiment of the present disclosure;

FIG. 14 is a perspective view of the bead stop tool according to the second embodiment of the present disclosure;

FIG. 15 is a perspective view of the dismounting tool according to the first embodiment of the present disclosure;

FIG. 16 is a perspective view of the multi-purpose workstation in a tire-mounting configuration according to the second embodiment of the present disclosure;

FIG. 17 is a cross-sectional view of the hub tool and the wheel according to the first embodiment of the present disclosure; and

FIG. 18 is a cross-sectional view of the hub tool and the wheel according to the second embodiment of the present disclosure.

### DETAILED DESCRIPTION

The present invention features a multi-purpose workstation for breaking tire beads from the rim of a wheel, removing tires from associated wheels, and remounting tire to a wheel.

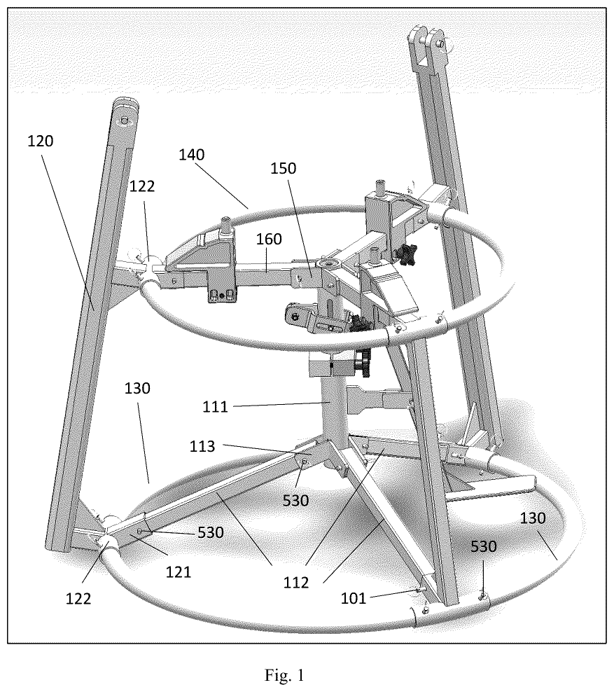

FIG. 1 is a perspective view of a frame of the multi-purpose workstation according to one embodiment of the present disclosure. The frame of the present embodiment has two main functions, namely, to provide a platform for a wheel to be mounted thereon and to couple with a bead-breaking tool, a tire demounting tool, or a tire mounting tool, depending on the operation to be executed.

As illustrated in FIG. 1, the frame includes an inner support, an outer support, and a plurality of support couplers. The inner support includes a first support tube 111 and three first legs 112 extending, at an angle, from one end of the first support tube 111 toward the ground. In the present embodiment, the two adjacent first legs 112 are spaced apart by approximately 120°. However, in different embodiments, the distance or angle between two adjacent first legs 112 can be different from that of another pair. One end of the first support tube 111 is disposed with three first slots 113, each configured to accommodate one end of the first leg 112. A first pin 530 is then used to couple the first leg and the first slot 113 together.

In the present embodiment, the outer support includes three second legs 120 each having a bottom portion, a mid-portion, and a top portion. As illustrated in FIG. 1, the bottom portion of the second leg 120 includes a second slot 121 and a pair of first receivers 122. The second slot 121 is configured to receive another end of the first leg 112, wherein another first pin 530 is then used to couple the second slot 121 and the first leg 112 together. Once the first support tube 111, first legs 112, and second legs 120 are coupled together, the foundation of the frame is complete. However, the forces required for breaking the bead of tire from wheel or dismounting tire from wheel can exert an incredible amount of force on the frame and therefore further reinforcement of the frame's integrity is recommended. To further strengthen the frame, a plurality of first reinforcement couplers 130 are provided to couple the adjacent second legs 120 together. In the present embodiment, the first reinforcement coupler 130 is a curved tube configured to couple with the bottom portions of two adjacent second legs 120. As mentioned above, each bottom portion of the second leg 120 includes two first receivers 122, each configured to receive one end of the first reinforcement coupler 130. A first pin 530 is then used to couple the first receiver 122 and the first reinforcement coupler 130 together.

The second leg 120 is configured to accommodate and couple with a rail 160 which is part of an assembly base that will be discussed later. The first receiver 122 is configured to receive and couple with a second reinforcement coupler 140. Similar to the first reinforcement coupler 130, the second reinforcement coupler 140 is a curved tube to be inserted in the first receiver 122. A first pin 530 is then used to couple the second reinforcement coupler 140 and the first receiver 122 together.

As illustrated in FIG. 1, the second legs 120 are not perpendicular to the ground. In fact, the bottom portion of the second leg 120 is configured to tilted at an angle to the ground. In the present embodiment, the distance between the mid-portions of two adjacent second legs 120 is shorter than that between the bottom portions of two adjacent second legs 120. Accordingly, the curvature as well as the length of the second reinforcement coupler 140 is different from those of the first reinforcement coupler 130. In different embodiments, the second legs 120 can be configured to be perpendicular to the ground or tilted away from the center of the frame. Thus, depending on the angular orientation of the second legs 120 with respect to the ground, the first and second reinforcement couplers 130, 140 can differ from each other in terms of length and curvature.

The top portion of the second leg 120 is configured to couple with a plurality of configuration sets, each having different purpose and configuration. For instance, the top portion of the second leg 120 can be rotatably coupled with a bead-breaking tool set and acts as a fulcrum to form a class two lever system with the bead-breaking tool set. The lever system allows a user to apply force on the bead-breaking tool set downward toward the tire in order to separate the bead from the bead seat of the wheel. The operation of bead-breaking will be explained in further details below.

As illustrated in FIG. 1, the other end of the first support tube 111 away from the first slot 113 is disposed with a plurality of third slots 150, each configured to receive one end of the rail 160. A first pin 530 is then used to couple the rail and the third slots 150 together. The mid-portion of the second leg 120 is also configured to receive the other end of the rail 160. A first pin 530 again is used to couple the rail 160 and the mid-portion of the second leg 120 together. The rail 160 is configured to couple with a tire seat for a tire portion of an assembly to be placed thereon. The tire seat is movably coupled with the rail 160 and the movability of the tire seat allows the user to adjust the position of the tire seat to accommodate tire/wheel assembly of different sizes. The interact between the tire seat and tire/wheel assembly will be explained in further details below.

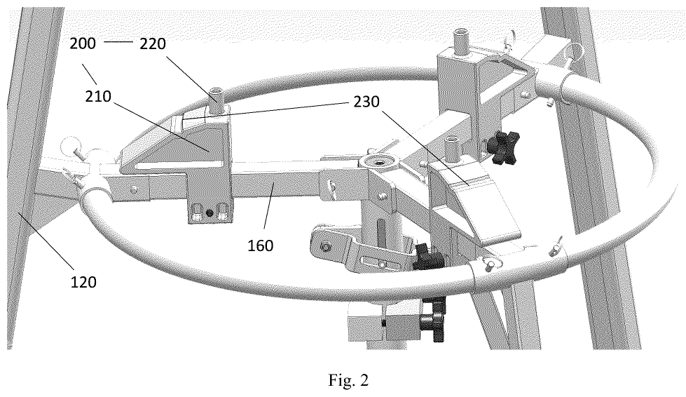

FIG. 2 is an enlarged view of the assembly base of the present disclosure. As illustrated, the assembly base includes a plurality of tire seats 200 to collectively form a platform for a tire/wheel assembly to be placed thereon. The other function of the tire seats 200 is to prevent the tire/wheel assembly, once placed on the assembly base, to rotate for more than a few degrees. How the above-mentioned functions are accomplished will be explained below.

The tire seat 200 of the present embodiment includes a tire base 210 and a spoke protrusion 220. The tire base 210 has a rail opening configured for the rail 160 to pass through that allows the tire base 210 to movably couple with the rail 160. The configuration allows the user to adjust the position of the tire base 210 on the rail 160 in order to accommodate tire/wheel assembly of different sizes. Preferably, the bigger the tire/wheel assembly, the closer the tire base 210 is moved toward the second leg 120 and away from the center of the workstation. Once the user determines the location of the tire seat 200 on the rail 160, the user can use the screw or other fixing means to fix the tire seat 210 on the rail 160.

In the present embodiment, the tire base 210 includes a tire contact portion 230 configure to contact a tire when the tire/wheel assembly is placed on the tire seats 200. The tire contact portion 230 is preferably sloped to accommodate the surface structure of the tire. More specifically, the tire contact portion 230 is sloped downward toward second leg 120 to maximize the circumference that can be formed on the collective tire seats for tire/wheel assembly of greater diameters. Also, to avoid causing damage to the wheel, the tire contact portion 230 preferably contact as little wheel as possible. To accomplish this, the tire base 210 has a cut-off portion for contacting just the part of the tire that meets the wheel but not the wheel itself. Further, the spoke protrusion 220 extends from the tire base 210 and is configured to be inserted between two adjacent spokes of a wheel, once the tire/wheel assembly is placed on the tire seats 200. The spoke protrusions 220 aim to contact a spoke of rotating wheel and then prevent the wheel from rotating any further. However, in different embodiments, the assembly base can include tire seats 200 without spoke protrusion 220 which allows the tire/wheel assembly to be rotated by the user during the bead-breaking or tire dismounting processes.

The assembly base of the present embodiment also includes features to fix the rim of the wheel on the assembly base to prevent the rim from moving vertically with respect to the ground, during the bead-breaking or tire dismounting operation. The workstation of the present embodiment includes a hub tool configured to couple with both a hub of the wheel and the assembly base. The user can then apply forces to pull the hub tool toward the ground in order to maintain the position of the wheel relative to the ground. The process of maintaining the wheel's position will be explained in further details below.

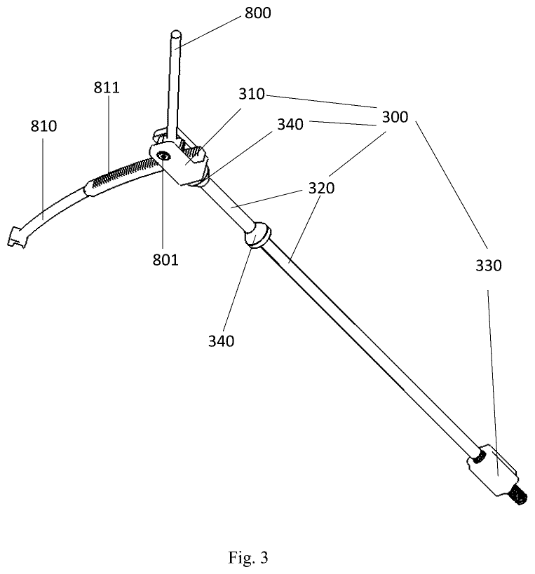

FIG. 3 is a perspective view of the hub tool of the present embodiment. FIG. 3 also illustrates the remounting handle 800, the push rod 810, and the rack portion 811 and their interaction with the hub tool will be further discussed in paragraphs [0057]-[0058] below. The hub tool 300 includes a tool head 310, a tool axle 320, tool bottom 330, and two first spacers 340. The hub tool 300 without the first spacers 340 can only contact the inner surface of a wheel hub of one specific diameter. The first spacers 340 allows the tool axle 320 to contact the inner surface of wheel hubs of greater diameters and therefore allows the hub tool 300 to accommodate wheel hubs of various sizes.

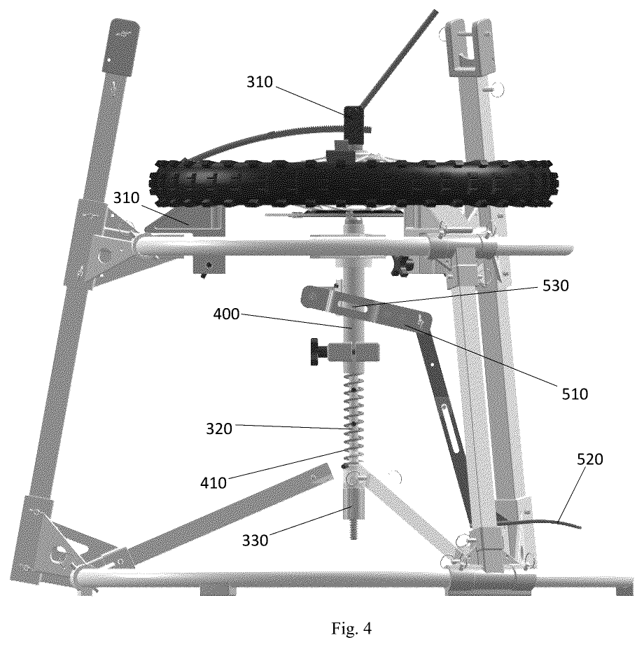

FIG. 4 is a perspective view of the workstation of the present embodiment, wherein a tire/wheel assembly is placed on the tire seats 200. To help illustrating the interaction between components for fixing the wheel on the assembly base, various components of the assembly base and the wheel are made transparent. As illustrated, the assembly base includes a tool coupler 400 disposed inside the first support tube 111. In the present embodiment, the inner surface of the tool coupler 400 is disposed with thread that corresponds to the thread on one end of the tool axle 320 (also illustrated in FIG. 3). Thus, when the tool axle 320 passes through the opening of the wheel hub, the tool axle 320 can then couple with the tool coupler 400 in the first support tube 111. Further, the assembly base includes an elastic element 410 disposed inside the first support tube 111 and between the bottom of the first support tube 111 and the tool coupler 400. The elastic element 410 is configured to buffer any force that pulls the combination of the hub tool 300 and tool coupler 400 toward the ground.

In the present embodiment illustrated in FIG. 4, the assembly base includes a pedal assembly coupled with the tool coupler 400 and configured to accept a downward force from user to pull the tool coupler 400 toward the ground. The pedal assembly includes an axle part 510, a pedal 520 coupled with one end of the axle part 510, and a first pin 530 configured to couple with the tool coupler 400 inside the first support tube 111.

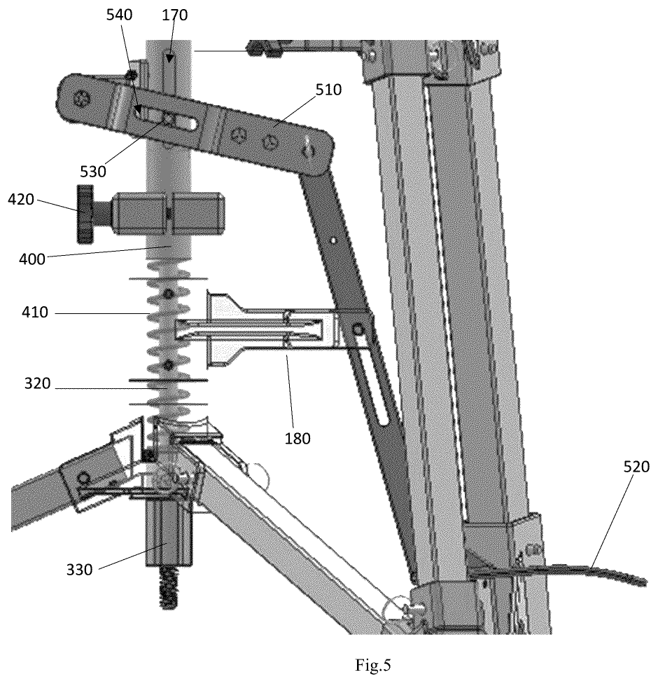

FIG. 5 is another enlarged view of the assembly base. The first support tube 111 (not illustrated) includes a pair of first elongated openings 170 opposite to each other. The tool coupler 400 also includes a pair of openings corresponding to the first elongated openings 170. Similarly, the axle part 510 of the pedal assembly includes a pair of second elongated openings 540 opposite to each other. A first pin 530 is then used on pass through the first clongated openings 170, the openings on the tool coupler 400, and the second elongated openings 540, to couple the tool coupler 400 with the pedal assembly. As illustrated in FIG. 5, the first support tube 111 includes a pedal protrusion 180. On the other hand, the pedal assembly includes a pedal 520 movably coupled with the pedal protrusion 180 and configured to accept a downward force from the user. The second elongated openings are disposed on the rotation portion of the pedal assembly. Also, as mentioned above, the tool coupler 400 is coupled with the hub coupler 300. Thus, the tool coupler 400 will pull both the hub coupler 300 and the wheel (illustrated in FIG. 4) downward.

As the tool coupler 400 is moved downward, the force will be absorbed by the clastic element 410 disposed inside the first support tube 111 and below the tool coupler 400. Further, the assembly base can include a tightening tool 420 configured to fix the position of the tool coupler 400 inside the first support tube 111. The tightening tool 420 of the present embodiment include a pair of tightening blocks having thread inside and a corresponding tightening screw. One end of the tightening screw is disposed with a screw handle for user to rotate and bring the tightening blocks toward each other. As the tightening blocks are moving toward each other, they begin to apply a clamping force on the tool coupler in order to fix the position of the tool coupler. Once the user determines that enough downward force is applied on the wheel to maintain its position, the user can then use the tightening tool 420 to fix the position of the tool coupler 400 inside the first support tube 111. The process of maintaining the wheel on the assembly base is complete the moment the tool coupler 400 is fixed in position using tightening tool.

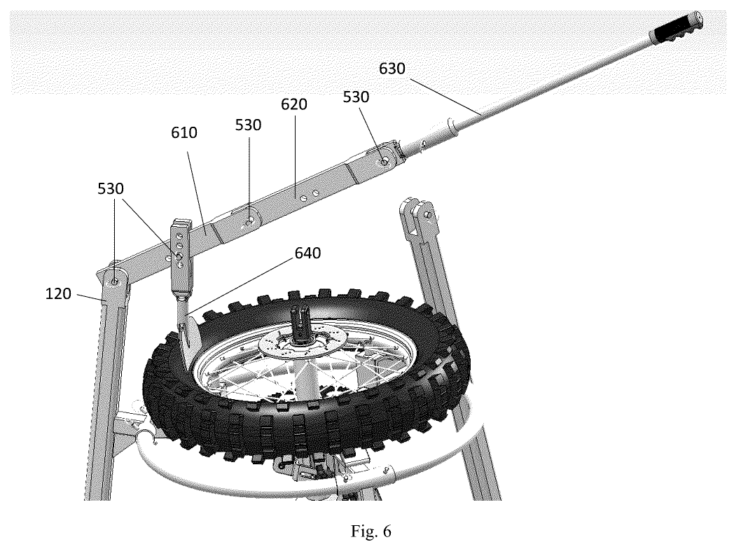

FIG. 6 is a perspective of the multi-purpose workstation in a bead-breaking configuration, according to one embodiment of the present disclosure. The workstation includes the assembly base as discussed above and a bead-breaking assembly. In the embodiment illustrated in FIG. 6, the tire/wheel assembly is placed on the assembly base and fixed in position as described above. The bead-breaking assembly includes a first extension 610, a second extension 620, a handle 630, and a bead-breaker 640. In the present embodiment, the first extension 610 and the second extension 620 are substantially identical in shape and structure. The two extensions 610, 620 both include a first end and a second end. In the present embodiment, the first end of the first extension 610 and the top portion of the second leg 120 are disposed with corresponding openings. A first pin 530 is used to pass through said openings to rotatably couple the first extension 610 and the second leg 120 together. The second end of the first extension 610 and the first end of the second extension 620 include corresponding openings for a first pin 530 to pass through and couple the two extensions 610, 620 together. Please note that the first and second extensions 610, 620 are preferably not rotatably coupled. One end of the handle 630 and the second end of the second extension 620 have corresponding openings for a first pin 530 to pass through and the second extension 620 and the couple the handle 630 together. Please note that the second extension 620 and the handle 630 are preferably not rotatably coupled.

The first extension 610 and the bead-breaker 640 each includes at least one opening for a first pin 530 to pass through and couple the first extension 610 and the bead-breaker 640 together. As illustrated in FIG. 6, the first extension 610 and the bead-breaker 640 each includes a plurality of the openings for the user to determine which openings for the first pin 530 to pass through, based on the size of the wheel and the location where the tire meets the rim.

The bead-breaker 640 includes a bead-breaking portion configured to apply forces on the tire, as the user push the handle downward toward the ground, to drive the bead of the tire off the seat of the rim (not illustrated). The bead-breaking portion of the present embodiment has a shape of a shovel and a flat edge. In other embodiments, the bead-breaking portion can have other shapes with preferably a flat edge configured to press the portion of the tire associated with its bead downward without causing damage.

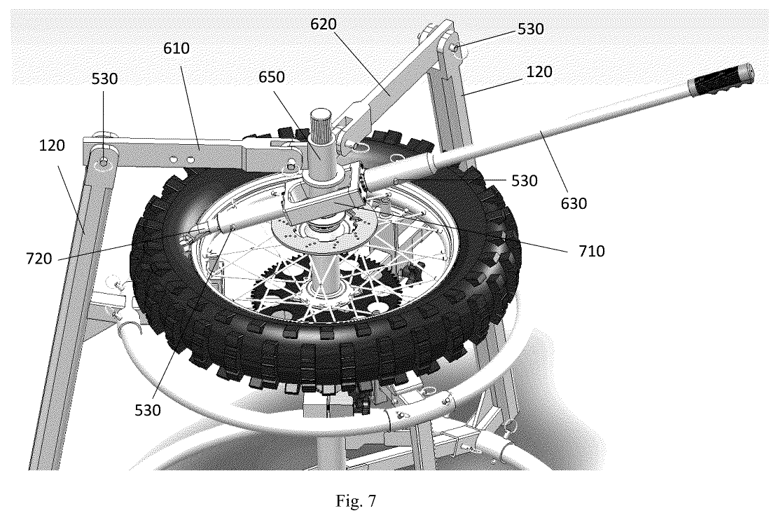

FIG. 7 is a perspective of the multi-purpose workstation in a tire-dismounting configuration according to one embodiment of the present disclosure. The workstation includes the assembly base as described above and a dismounting assembly. In the embodiment illustrated in FIG. 7, the tire/wheel assembly is placed on the assembly base and fixed in position as described above. The dismounting assembly includes the first extension 610, the second extension 620, a pivot support 650, and the dismounting tool that includes the handle 630, the pivot member 710, and the dismounting member 720.

The pivot support 650 is configured to couple with the hub of the wheel. In the present embodiment, the pivot support 650 is coupled with the hub tool 300 (not illustrated) which is coupled with the hub coupler 400 within the first support tube 111 and whose position on the wheel is fixed. The process of fixing the position of the hub tool 300 with respect to the wheel is described above and thus will not be repeated here. Accordingly, the pivot support 650 is now also fixed in position on the assembly base.

As illustrated in FIG. 7, the pivot support 650 includes two support protrusions configured to be coupled with the first extension 610 and the second extension 620, respectively. In the present embodiment, the first extension 610 and the second extension 620 are substantially identical in shape and structure. The two extensions 610, 620 both include a first end and a second end. In the present embodiment, the first end of the first extension 610 and the top portion of the second leg 120 are disposed with corresponding openings. A first pin 530 is used to pass through said openings to rotatably couple the first extension 610 and the second leg 120 together. Similarly, the first end of the second extension 620 and a top portion of another second leg 120 are disposed with corresponding openings. A first pin 530 is used to pass through said openings to rotatably couple the first extension and another second leg 120 together. The second ends of both the first extension 610 and second extension 620 are respectively coupled with the pivot support 650 as illustrated in FIG. 7.

As mentioned above, the dismounting tool includes the handle 630, the pivot member 710, and the dismounting member 720. The pivot member 710 of the present embodiment is substantially a rectangular ring having an opening for the pivot support 650 to pass through. In other words, the pivot member 710 is configured to surround the pivot support 650. In the present embodiment, the pivot member 710 has a rectangular shape. However, in different embodiments, the pivot member 710 can also have circular shape or other shape suitable for having a central opening to surround the pivot support 650.

In the embodiment illustrated in FIG. 7, the pivot member 710 has a first protrusion configured to receive one end of the handle 630 and a second protrusion configured to receive the dismounting member 720. In the present embodiment, the first protrusion and the handle 630 have corresponding openings for a first pin 530 to pass through and couple the first protrusion and the handle 630 together. Similarly, the second protrusion and the dismounting member 720 have corresponding openings for a firs pin 530 to pass through and couple the second protrusion and the dismounting member 720 together.

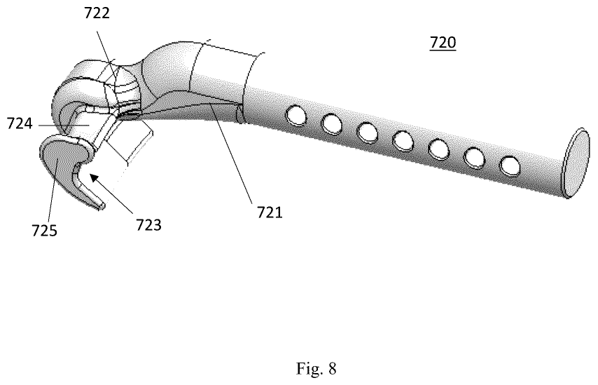

FIG. 8 is a perspective view of the dismounting member 720 of the present embodiment. One end of the dismounting member 720 is configured to be inserted in the second protrusion of the pivot member 710, as described above. The other end of the dismounting member 720 is configured to be inserted in the inner space of the tire, after the tire bead is moved out of the bead seat of the wheel in the previous bead-breaking process. The dismounting member 720 has an end portion 721 tilted in order to facilitate the process of being inserted in the inner space of the tire. The contact surface 722 of the end portion 721 will contact the inner surface of the tire during the tire dismounting process described below.

Once the multi-purpose workstation is in the tire-dismounting configuration, the user can start dismounting the tire from the rim by inserting one end of the dismounting member 720 into the inner space of the tire. The user can then use the contact point between the end portion 721 and the rim to create a leverage and push the handle 630 downward, to move part of the tire away from the rim. Further, as illustrated in FIG. 7, the ring-shaped pivot member 710 allows the tool to be rotated with the pivot support 650 as its axis. Thus, the user can repeat the above-mentioned tire-dismounting process while rotating the pivot member 710 to further separate the tire from the wheel. In the present embodiment, the pivot member 710 can no longer be rotated if the handle 630 contact either one of the two second legs 120. Thus, the angle that the tool can be rotated is based partly on the positions of the second legs 120.

In another embodiment of the present invention, the dismounting member 720 includes a rim slot 723 configured to contact the rim once the dismounting member 720 is inserted in the inner space of the tire. The dismounting member 720 also includes an iron groove 724 formed between the contact surface 722 and an extension 725 and configured for a tire iron to be inserted therein. Once the tool is assembled, the user can start dismounting the tire from the wheel by inserting one end of the dismounting member 720 into the inner space of the tire. The rim slot 723 will contact and grip a rim of wheel. The user can then insert a tire iron in the iron groove 724 and underneath the tire to then wedge the tire over the contact surface 722. Once the tire is over the contact surface 722 the user can rotate the handle 630 around the tire until the tire can be further separated from the wheel.

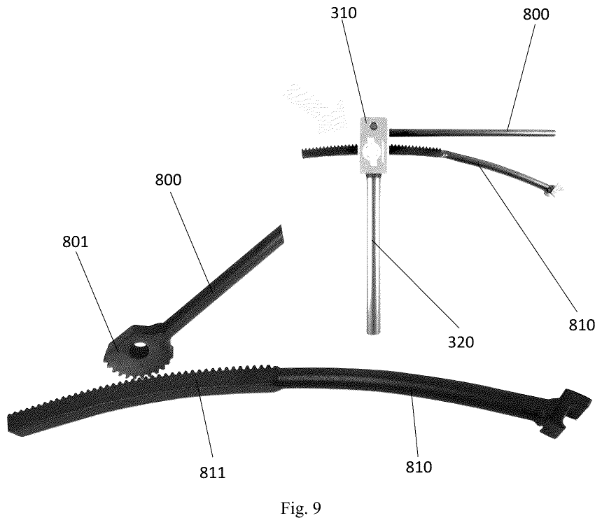

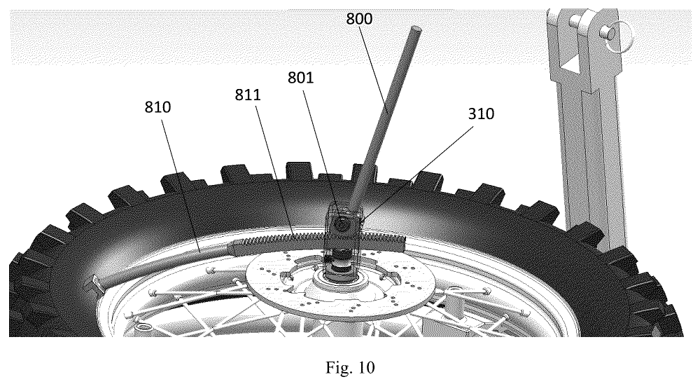

FIGS. 9 and 10 illustrate a perspective view of a tire remounting tool to be coupled with the frame of FIG. 1 and the assembly base in FIG. 2. The tire remounting tool of the present embodiment includes a remounting handle 800 and a push rod 810 to be coupled with the tool head 310 of the hub tool 300 illustrated in FIG. 3. As illustrated in FIGS. 3 and 9, the tool head 310 and the remounting handle each includes a corresponding opening, wherein a bolt or other suitable fasteners passes through the openings and allows the remounting handle 800 to rotatably couple with the tool head 310. Also, as illustrated in FIGS. 9-10, one end of the remounting handle 800 includes a pinion portion 801 and one end of the push rod 810 includes a rack portion 811, wherein the pinion portion 801 and the rack portion 811 are disposed with corresponding teeth. In the present embodiment, the push rod 810 is placed within the slot of the tool head 310 with the rack portion 811 facing upward. On the other hand, the pinion portion 801 of the remounting handle 800 is rotatably placed in the tool head 310 and configured to interact with the rack portion 811. Furthermore, in the present embodiment, the tool axle 320 is not coupled with the tool coupler 400 so that the hub tool 300 can be rotatably coupled with the base as illustrated in FIG. 10.

Here please refer to both FIGS. 9-10 for remounting a tire on the wheel. In the embodiment illustrated in FIG. 10, a wheel is maintained on the base. A user can start remounting the tire to the wheel by rotating the remounting handle 800, so that the pinion portion 801 can interact with the rack portion 811 and translate the rotation of the pinion portion 801 to a linear movement of the push rod 810 toward the tire. As the push rod 810 moves toward the tire, it will push part of the tire over a flange of the wheel, so that the user can push that part of the tire downward in order for the tire bead is placed on the bead seat of the wheel. In order to completely remount the tire to the wheel, the user needs to repeat the above-mentioned process until the entire tire is properly mounted on the wheel.

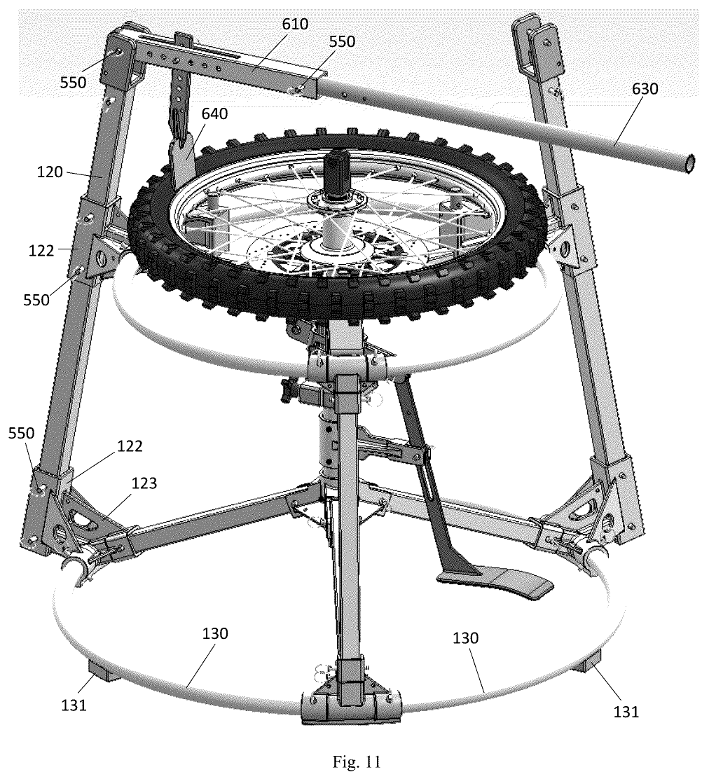

FIG. 11 illustrates a perspective of the multi-purpose workstation in a bead-breaking configuration according to a second embodiment of the present disclosure. As illustrated in FIG. 11, the workstation in the bead-breaking configuration is substantially similar to the one illustrated in FIG. 6. However, there are several notable differences that will be described below.

Firstly, the receiver 122 illustrated in FIG. 11 is structurally different from that illustrated in FIG. 1. The receiver 122 in FIG. 11 further includes additional ribs 123 compared with the receiver 122 illustrated in FIG. 6. The receiver 122 is configured to receive the second leg 120 or allow the second leg 120 to pass through. For instance, one receiver 122 is configured to have a socket to receive one end of the second leg 120 and several second pins 550 are used to couple the second leg 120 and the receiver 122 to increase the overall load compacity of the frame. Also, the socket of the receiver 122 can be configured to allow the second leg 120 to pass through. Several second pins 550 are then used to couple the receiver 122 with the mid-portion of the second leg 120 to further increase the overall load compacity of the frame. The frame also includes a plurality of base stands 131 each coupled with one the first reinforcement couplers 130, wherein the base stands 131 is configured to contact the ground and share the load with the receivers 122.

Secondly, the bead-breaking assembly illustrated in FIG. 11 is also structurally different from that illustrated in FIG. 6. The bead-breaking assembly of the second embodiment includes a first extension 610, a handle 630, and a bead-breaker 640. The bead-breaker 640 is substantially identical to the one illustrated in FIG. 6 and thus will not be described here again. One end of the first extension 610 is rotatably coupled with the second leg 120 using a second pin 550 while the other end of the first extension 610 is coupled with the handle 630 using the second pin 550 as well. Further, a plurality of openings are formed on the handle 630 so that the user can selectively couple the first extension 610 to one of many sections of the handle 630. Also, openings are formed on the first extension 610 so that the user can selectively couple the bead-breaker 640 to one of many sections of the handle 630, based on the size of the tire/wheel assembly and the location where the tire meets the wheel.

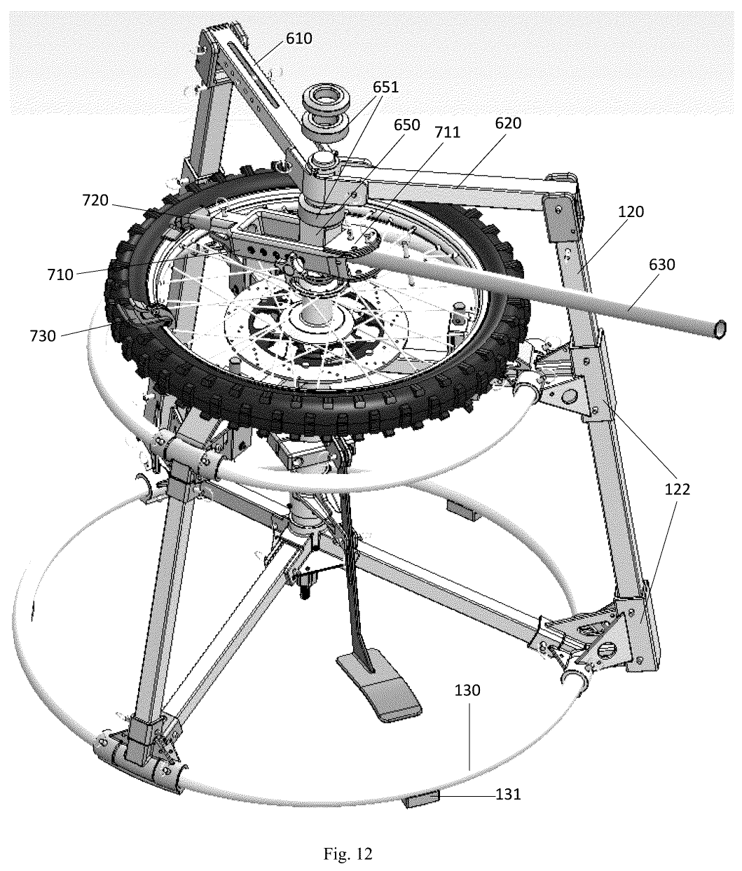

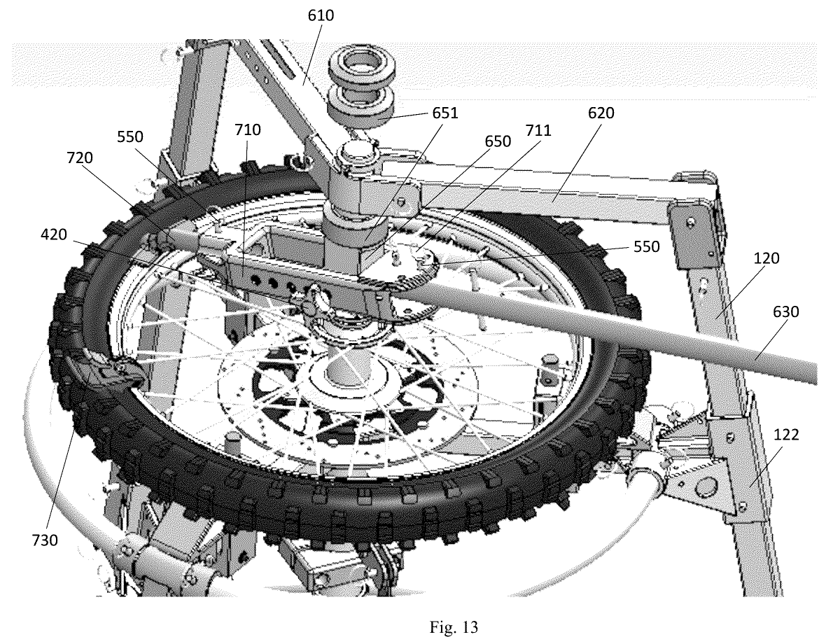

FIG. 12 illustrates a perspective of the multi-purpose workstation in a tire dismounting configuration according to the second embodiment of the present disclosure. FIG. 13 is an enlarged view of the same multi-purpose workstation in the tire dismounting configuration. As illustrated in FIGS. 12-13, the workstation is substantially similar to the one illustrated in FIG. 7. However, there are several notable differences that will be described below.

The pivot support 650 is configured to couple with the hub of the wheel. In the present embodiment, the pivot support 650 is coupled with the hub tool 300 (not illustrated) which is coupled with the hub coupler 400 within the first support tube 111 and whose position on the wheel is fixed. The process of fixing the position of the hub tool 300 with respect to the wheel is described above and thus will not be repeated here. The pivot support 650 is now also fixed in position on the frame. The pivot support 650 further includes one or more second spacers 651 placed between the extensions 610, 620 and the pivot support 650 in the event that the thickness of the wheel is small which leaves a gap between the extensions 610, 620 and the pivot support 650.

In the second embodiment, the tire-dismounting tool includes the handle 630, the pivot member 710, and the dismounting member 720. However, the pivot member 710 and the dismounting member 720 illustrated in FIGS. 12-13 have additional features that differentiate themselves from their counterparts in the first embodiment illustrated in FIG. 7.

The pivot member 710 of the present embodiment is substantially a rectangular ring having an opening for the pivot support 650 to pass through. Thus, the pivot member 710 is configured to surround the pivot support 650. The pivot member 710 illustrated in FIGS. 12-13 has a rectangular shape. However, in different embodiments, the pivot member 710 can also have circular shape or other shape suitable for having a central opening to surround the pivot support 650. The ring-shaped pivot member 710 allows the assembled tire-dismounting tool to be rotated around the pivot support 650.

The pivot member 710 has a first socket 711 configured to receive the handle 630. The first socket 711 includes a plurality of openings for the user to couple the handle 630 with the first socket 711 using a second pin 550. More importantly, the handle 630 can be coupled with the first sockets 711 and be oriented at different angles to give the user extra angle to further rotate the tire-dismounting tool around the pivot support 650. As illustrated in FIG. 13, the handle 630 is coupled with the middle opening of the first socket 711 to be substantially parallel with the pivot member 710. If the user need to rotate the tire-dismounting tool but is unable to do so because of the second leg 120 obstructing the handle 630. The user can then couple the handle 630 with the left or right most opening on the first socket 711 so that the handle 630 is no longer parallel with the pivot member 710, which also gives the user additional space to further rotate tire-dismounting tool before the second leg 120 obstructs the handle 630 again.

Further, the pivot member 710 includes a plurality of openings formed along a length of the pivot member 710. The user can selectively uses the tightening tool 420 to couple the pivot support 650 to one of many sections of the pivot member 710 based on the diameter of the tire/wheel assembly.

Also, the pivot member 710 illustrated in FIG. 13 has an extension opposite to the first socket 711 that is configured to receive the dismounting member 720, wherein said extension and the member 720 have corresponding openings for a second pin 550 to pass through and couple the pivot member 710 with the dismounting member 720.

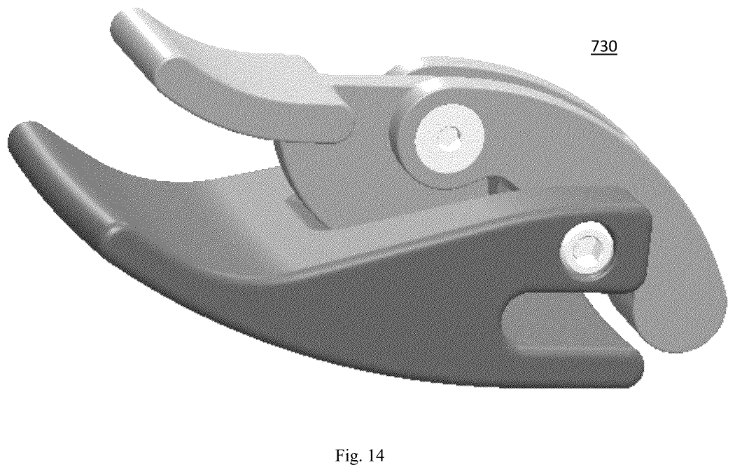

The multi-purpose workstation illustrated in FIGS. 12-13 further includes at least one bead stop tool 730 configured to couple with the wheel rim. FIG. 14 is a perspective of the bead stop tool 730. In practice, the bead stop tool 730 couples with the wheel rim to occupy the bead seat of the wheel to obstruct the bead of the tire separated from the bead seat and prevent the bead from returning to said bead seat. The bead stop tool, with its three-part ergonomic assembly, utilizes a cantilever-style clamping mechanism to remain securely fixed to the wheel rim. The bead stop tool 730 is designed to engage the space between the tire bead and wheel rim, maintaining the bead's position during tire mounting and tire dismounting. This bead stop tool 730 simplifies the process of changing tires on off-road motorcycles by providing a positive stop of tire bead to wheel rim slippage during tire mounting and tire dismounting. In different embodiments, the bead stop tool 730 can include other fastening device configured to be removably coupled with the wheel rim and used to occupy or engage the space between the tire bead and wheel rim and maintaining the bead's position during tire mounting and tire dismounting. Please note that the bead stop tool 730 is an option for the user to provide a positive stop of tire bead to wheel rim slippage during tire mounting and tire dismounting. However, the bead stop tool 730 is not necessary and the tire dismounting configuration of the multi-purpose workstation is configurated to effectively separate the tire from the wheel even without the use of the bead stop tool 730.

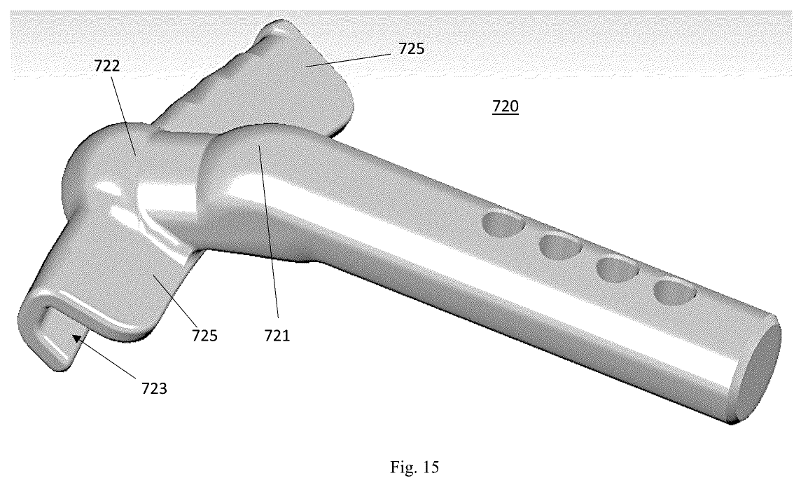

FIG. 15 is a perspective view of the dismounting member 720 of the present embodiment. One end of the member 720 is configured to be inserted in the above-mentioned protrusion of the pivot member 710 to be coupled therewith. The other end of the dismounting member 720 is configured to be inserted in the inner space of the tire, after the tire bead is separated from the bead seat of the rim in the previous bead-breaking process. The dismounting member 720 has a tilted end portion 721 configured to facilitate the process of being inserted in the inner space of the tire. The contact surface 722 of the end portion 721 will contact the inner surface of the tire during the tire dismounting process described below.

Once the dismounting tool is assembled, the user can start dismounting the tire from the wheel rim by inserting one end of the dismounting member 720 into the inner space of the tire. The user can then use the contact point between the end portion 721 and the wheel rim to create a leverage and push the handle 630 downward, to move part of the tire away from the rim. Further, the ring-shaped pivot member 710 (illustrated in FIGS. 12-13) allows the dismounting tool to be rotated around the pivot support 650. Thus, the user can repeat the above-mentioned tire-dismounting process while rotating the dismounting tool to separate the tire from the wheel rim.

As illustrated in FIG. 15, the dismounting member 720 further includes two dismounting arms 725 extending from two opposite sides of the end portion 721. Further, the end portion 721 and the two dismounting arms 725 includes a rim slot 723 configured to contact the wheel rim once the dismounting member 720 is inserted in the inner space of the tire. Once the tool is assembled, the user can start separating the tire from the wheel by inserting one end of the dismounting member 720 into the inner space of the tire. The rim slot 723 will contact and grip the wheel rim. The user can then place a tire iron on either one of the dismounting arms 725 and underneath the tire to then wedge the tire over the contact surface 722. Once the tire is flipped over the contact surface 722 the user can rotate the handle 630 around the pivot support 650 until the tire can be separated from the wheel rim.

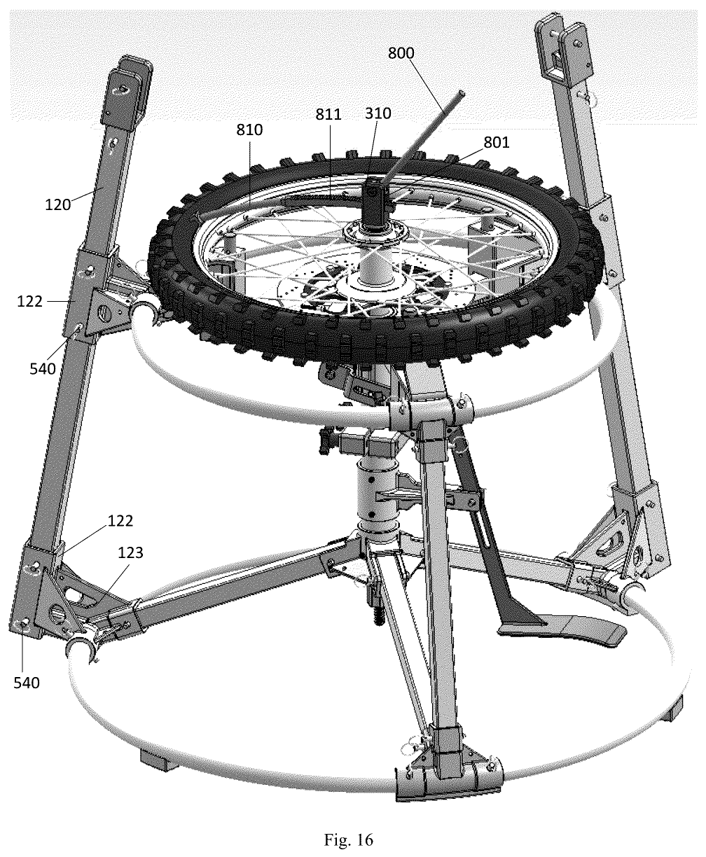

FIG. 16 illustrates a perspective view of the multi-purpose workstation in a tire-mounting configuration according to the second embodiment of the present disclosure. The tire remounting tool includes a remounting handle 800 and a push rod 810 to be coupled with the tool head 310 of the hub tool 300 similar to the ones illustrated in FIG. 3. As illustrated in FIGS. 3 and 16, the tool head 310 and the remounting handle 800 each includes a corresponding opening, wherein a bolt or other suitable fasteners passes through said opening and allows the remounting handle 800 to rotatably couple with the tool head 310. Also, one end of the remounting handle 800 includes a pinion portion 801 and one end of the push rod 810 includes a rack portion 811, wherein the pinion portion 801 and the rack portion 811 are disposed with corresponding teeth. The push rod 810 is placed within the slot of the tool head 310 with the rack portion 811 facing upward. On the other hand, the pinion portion 801 of the remounting handle 800 is rotatably placed in the tool head 310 and configured to interact with the rack portion 811.

A user can start remounting the tire to the wheel by rotating the remounting handle 800, so that the pinion portion 801 can interact with the rack portion 811 and translate the rotation of the pinion portion 801 to a linear movement of the push rod 810 toward the tire. As the push rod 810 moves toward the tire, it will push part of the tire over a flange of the wheel, so that the user can push that part of the tire downward in order for the tire bead is placed on the bead seat of the wheel. In order to completely remount the tire to the wheel, the user needs to repeat the above-mentioned process until the entire tire is properly mounted on the wheel.

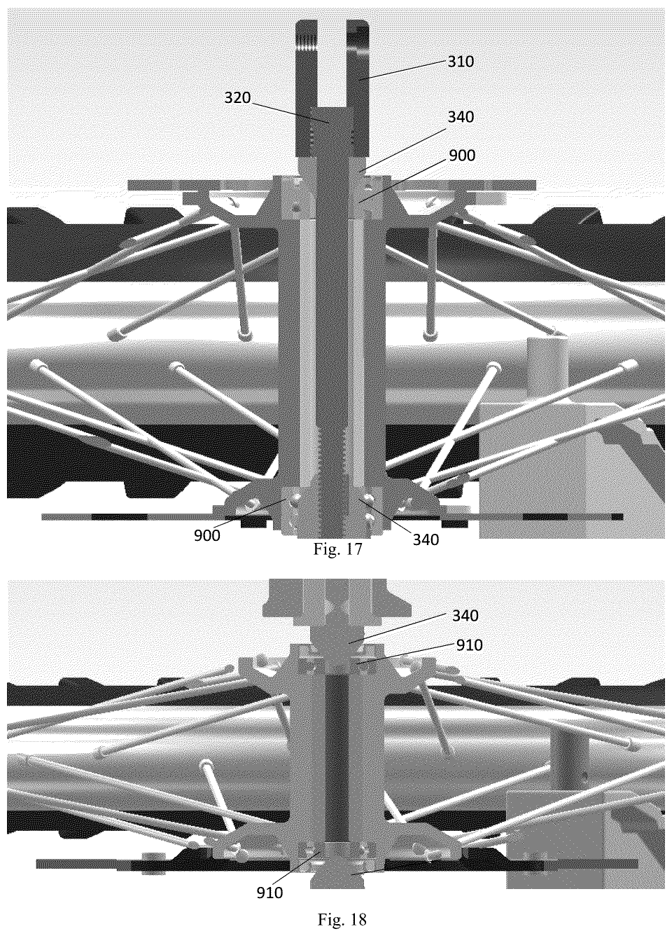

FIG. 17 is a cross-sectional view of the hub tool (illustrated in FIG. 3) and a tire/wheel assembly according to the first embodiment of the present disclosure. On the other hand, FIG. 18 is a cross-sectional view of the hub tool (illustrated in FIG. 3) and another tire/wheel assembly according to the second embodiment of the present disclosure. Please note that the tire/wheel assembly in FIG. 17 and the tire/wheel assembly in FIG. 18 have different widths/thickness.

As illustrated in FIGS. 3 and 17-18, the first spacer 340 of the hub tool 300 has a conical portion that tapers smoothly from one end to the other end. In FIG. 17, the conical portion of the first spacer 340 is configured to contact the first ball bearing ring 900 of the first wheel to ensure that there is no space between the first spacer 340 and the first ball bearing ring 900, when the wheel is tightly maintained on the assembly base in FIG. 17 of the first embodiment. In FIG. 18, the conical portion of the first spacer 340 is also configured to contact the second ball bearing ring 910 of the second wheel to ensure that there is no space between the first spacer 340 and the second ball bearing ring 910, when the wheel is tightly maintained on the assembly base in FIG. 18 of the second embodiment.

As mentioned above, the first wheel in FIG. 17 and the second wheel in FIG. 18 have different widths. In FIG. 17, the first ball bearing ring 900 contact the middle section of the first spacer 340. On the other hand, the second ball bearing 910 in FIG. 18 contact the bottom section of the first spacer 340. In both cases, there is no space between the first spacer 340 and the respective ball bearing ring 900/910, when the respective wheel is tightly maintained on the base 100. Thus, FIGS. 17-18 show that the conical first spacer 340 is configured to accommodate wheels of different diameters.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

1. A multi-purpose workstation system for an assembly having a wheel and a tire, comprising:
a platform having:
a frame;
an assembly base coupled to the frame and configured for the assembly to be attached thereon, wherein the multi-purpose workstation system further includes at least one of: a bead-breaking set detachably coupled with the base and configured for a user to move a bead of the tire away from a bead seat of the wheel; a dismounting set detachably coupled with the base and configured to separate the tire from the wheel; and a mounting set detachably coupled with the base and configured for the user to move and install the tire on the wheel.

2. The multi-purpose workstation system of claim 1, wherein the frame includes:
an inner portion having:
a plurality of first legs, wherein the adjacent first legs are displaced from each other by a first angle, two ends of the first leg are respectively coupled with the assembly base; and
an outer portion surrounding the assembly base and having:
a plurality of second legs, wherein the adjacent second legs are displaced from each other by a second angle; and
a plurality of leg couplers configured to couple two adjacent second legs.

3. The multi-purpose workstation system of claim 1, wherein the assembly base includes:
a seat movably coupled with the frame;
a hub tool configured to couple with the seat and a hub of the wheel;
a wheel fixing element configured to couple with the hub tool; wherein
the assembly is first placed on the seat and then the hub of the wheel is coupled with the hub tool, the wheel fixing element can then be pulled by the user toward a ground and in the process pulls the hub tool and the assembly toward the seats.

4. The multi-purpose workstation system of claim 3, wherein the hub tool includes:
a hub tool axle; and
a pair of spacers respectively coupled with two opposite ends of the hub tool axle, wherein the spacers is conical so that the hubs of different widths contact different parts of a linear contact point of the spacer when the hub tool is coupled with the hubs of the wheels.

5. The multi-purpose workstation system of claim 1, wherein the bead of the tire firmly adheres to the bead seat of the wheel, the bead-breaking set includes:
a handle;
a first arm including a proximal end detachably coupled with the handle and a distal end detachably coupled with the frame; and
a bead breaker detachably coupled with the first arm and extending toward the tire;
wherein the user applies a force on the handle to move the first arm and the bead breaker toward the tire so that the bead breaker presses the tire and moves the bead away from the bead seat of the wheel.

6. The multi-purpose workstation system of claim 1, wherein the bead is separated from the bead seat of the wheel and located on a first side of the wheel, the dismounting set includes:
an assembly stabilizer coupled with the frame and the assembly base;
a second arm movably coupled with the assembly stabilizer, wherein the second arm has a proximal end and a distal end;
a handle detachably coupled with the proximal end of the second arm;
a tire tool detachably coupled with the distal end of the second arm, wherein the user applies a force on the handle to use the tire tool to create a gap between the tire tool and the tire; and
a tire iron, wherein the user insert the tire iron into an inner space of the tire through the gap, the user then uses the tire tool as a fulcrum and the tire iron as a lever to bring the tire from the first side of the wheel to a second side of the wheel.

7. The multi-purpose workstation system of claim 6, wherein the tire tool includes:
a tool body; and
a first tool arm extending from a first side of the tool body, wherein the first tool arm has a first protrusion that forms a tire iron slot together with the tool body; and
a wheel grip extending from the tool body and forms a groove for the wheel grip to contact and grip the wheel.

8. The multi-purpose workstation system of claim 7, further comprising a coupler A configured to couple the second arm to the assembly stabilizer, wherein the second arm includes a plurality of openings formed along a length of the second arm, the user selectively uses the coupler A to couple the second arm to the assembly stabilizer based on the diameter of the wheel.

9. The multi-purpose workstation system of claim 7, wherein the handle is detachably coupled with the second arm, the user can selectively couple the handle with different parts of the second arm at different angles.

10. The multi-purpose workstation system of claim 1, wherein the tire is separated from the wheel, the multi-purpose workstation further comprises a third configuration set detachably and rotatably coupled with the assembly base, the third configuration set is configured to:
push the bead of tire over a rim of the wheel on one side of the wheel; and
push a tire body of the tire over the rim of the wheel on one side of the wheel.

11. A multi-purpose workstation system for an assembly having a wheel and a tire, comprising:
a platform having:
a frame;
an assembly base coupled to the frame and configured for the assembly to be attached thereon; and
one or more configuration sets detachably coupled with the platform, including at least one of a bead breaking configuration, a tire separation configuration, a demounting configuration and a remounting configuration.

12. The multi-purpose workstation system of claim 11 wherein the system is collapsible and wherein a user can select one or more of the configurations.

13. A method of working on an assembly having a wheel and a tire, comprising:
providing a frame of a platform configuration for the assembly to be maintained thereon;
coupling the assembly to the frame using an assembly base of the platform;
detachably coupling a first configuration set with the platform;
separating the tire from the wheel using the first configuration set;
decoupling the first configuration set from the platform;
detachably coupling a second configuration set with the platform; and
installing the tire on the wheel using the second configuration set.

14. The method of working on an assembly of claim 13, wherein the step of separating the tire from the wheel includes:
separating a bead of the tire from a bead seat of the wheel using the first configuration set;
decoupling the first configuration set from the platform;
detachably coupling a third configuration set with the platform; and
further separating the tire from the wheel using the third configuration set.

15. The method of working on an assembly of claim 13, wherein the step of providing the frame includes:
assembling an inner portion of the frame having a plurality of first legs, wherein the adjacent first legs are displaced from each other by a first angle, two ends of the first leg are respectively coupled with the assembly base;
coupling the inner portion with the assembly base;
assembling an outer portion of the frame around the assembly base, wherein the outer portion has:
a plurality of second legs, wherein the adjacent second legs are displaced from each other by a second angle; and
a plurality of leg couplers configured to couple two adjacent second legs; and
coupling the outer portion with the assembly base.

16. The method of working on an assembly of claim 13, wherein the step of coupling the assembly to the frame using an assembly base includes:
movably coupling a seat of the assembly base with the frame;
coupling a hub tool of the assembly base with the seat and a hub of the wheel;
coupling a wheel fixing element of the assembly base with the hub tool; and
pulling the wheel fixing element toward a ground and then maintaining the position of the wheel fixing element to maintain the assembly on the assembly base.

17. The method of working on an assembly of claim 13, wherein the bead of the tire firmly adheres to the bead seat of the wheel,
the first configuration set includes:
a handle;
a first arm including a proximal end detachably coupled with the handle and a distal end detachably coupled with the frame; and
a bead breaker detachably coupled with the first arm and extending toward the tire;
the step of separating the tire from the wheel includes applying forces on the handle to move the first arm and the bead breaker toward the tire so that the bead breaker presses the tire and moves the bead away from the bead seat of the wheel.

18. The method of working on an assembly of claim 13, wherein the bead is separated from the bead seat of the wheel and located on a first side of the wheel, the first configuration set includes:
an assembly stabilizer coupled with the frame and the assembly base;
a second arm movably coupled with the assembly stabilizer, wherein the second arm has a proximal end and a distal end;
a handle detachably coupled with the proximal end of the second arm; and
a tire tool detachably coupled with the distal end of the second arm, wherein the user applies a force on the handle to use the tire tool to create a gap between the tire tool and the tire;
the step of separating the tire from the wheel includes applying forces on the handle to use the tire tool to bring the tire from the first side of the wheel to a second side of the wheel.

19. The method of working on an assembly of claim 13, wherein the step of separating the tire from the wheel further includes:
selectively coupling the assembly stabilizer with one of many sections of the second arm based on the diameter of the wheel; and
selectively couple the handle with one of many sections of the second arm at different angles.

20. The method of working on an assembly of claim 13, wherein the tire is separated from the wheel, wherein the step of installing the tire on the wheel includes:
coupling the second configuration set detachably and rotatably with the assembly base;
using the second configuration set to push the bead of tire over a rim of the wheel on one side of the wheel; and
using the second configuration set to push a tire body of the tire over the rim of the wheel on one side of the wheel.
